(19) United States
(12) Patent Application Publication
(10) Pub. No.: US 2002/0011981 A1
(43) Pub. Date: Jan. 31, 2002

(54) Display device

(75) Inventor: Karel Elbert Kuijk, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/906,604

(22) Filed: Jul. 17, 2001

(30) Foreign Application Priority Data
Jul. 20, 2000 (EP) 00202605.2

(51) Int. Cl. G09G 3/36

(52) U.S. Cl. 345/92

(57) ABSTRACT

A new switch circuit is proposed for use in display devices, comprising a series switch of complementary TFT transistors (11, 12) per pixel (8, 25). Simultaneous selection of the transistors provides low power applications. On the other hand, logic functions may be implemented.

The invention relates to a display device comprising, on a substrate, a matrix of selection electrodes and data electrodes, with a pixel and at least a field effect transistor of a first type at the area of a crossing of the selection electrodes and data electrodes.

Examples of such an active matrix display device are the TFT-LCDs or AMLCDs which are used in laptop computers and in organizers, but they are also increasingly used in GSM telephones.

A problem in many portable display devices is the power consumption. This problem also occurs when the display device is constructed as a reflective display device (in which the power consumption for a backlight is avoided).

In such portable applications, the required drive voltages for the liquid crystal display cell are supplied by a drive IC for which the supply voltage is usually obtained by means of (capacitive) voltage multiplication (boosting). The conventional AM-LCDs usually require voltages of the order of 20 to 25 volts for driving TFT transistors, while drive voltages of 10 volts or less are sufficient for a known electro-optical effect such as the supertwist liquid crystal effect.

It is an object of the present invention to provide a display device of the type described in the opening paragraph, having a lower power consumption so that it can be used for a longer period of time with a single battery load.

To this end, a display device according to the invention is characterized in that the display device comprises, between the data electrode and the pixel, in series with the field effect transistor of the first type, at least a second field effect transistor of a second, opposite type, the gate electrode of one of the field effect transistors being connected to a selection electrode.

Although the voltage at the data electrode is usually variable, a selection electrode as described in the present application is sometimes also understood to be an electrode to which a fixed voltage (reference) is supplied.

The invention is based on the recognition that, notably when using polycrystalline silicon or even monocrystalline silicon, both field effect transistors of the first type and field effect transistors of the second, opposite type (for example, p type and n type transistors) can be made on one and the same substrate of, for example, glass or a synthetic material. A considerable reduction of the power consumption can thereby be realized, as compared with the conventional AM-LCDs in which field effect transistors of only one type are used. Notably when using liquid crystal display cells, in which the polarity across the cell is changed at each frame, very low voltages are sufficient. The invention may also be used to advantage for other types of display devices such as active matrices based on (O) LEDs or polymer LEDs.

In a first embodiment, the gate electrode of the first field effect transistor of the first type is connected to the selection electrode.

A further embodiment of the display device according to the invention is characterized in that the gate electrode of the second field effect transistor of the second type is connected to an extra selection electrode. The extra selection possibility obtained in this manner may be utilized in different ways. For example, selection pulses may be simultaneously applied to the gate electrodes of the field effect transistors, but the display device may also comprise drive means for supplying selection pulses to the gate electrode of the first field effect transistor and for a conditioned supply of selection pulses to the gate electrode of the second field effect transistor. This conditioned supply provides the possibility of rendering (parts of) the display device inoperative (temporarily or not temporarily) or using them at a lower frequency so that the dissipation is even further reduced.

Another embodiment of the display device according to the invention is characterized in that the gate electrode of the second field effect transistor of the second type is connected to a data electrode. In this way, it can be achieved, for example, that, dependent on the presence of information, the second field effect transistor is turned on or not turned on.

These and other aspects of the invention are apparent from and will be elucidated with reference to the embodiments described hereinafter.

In the drawings:

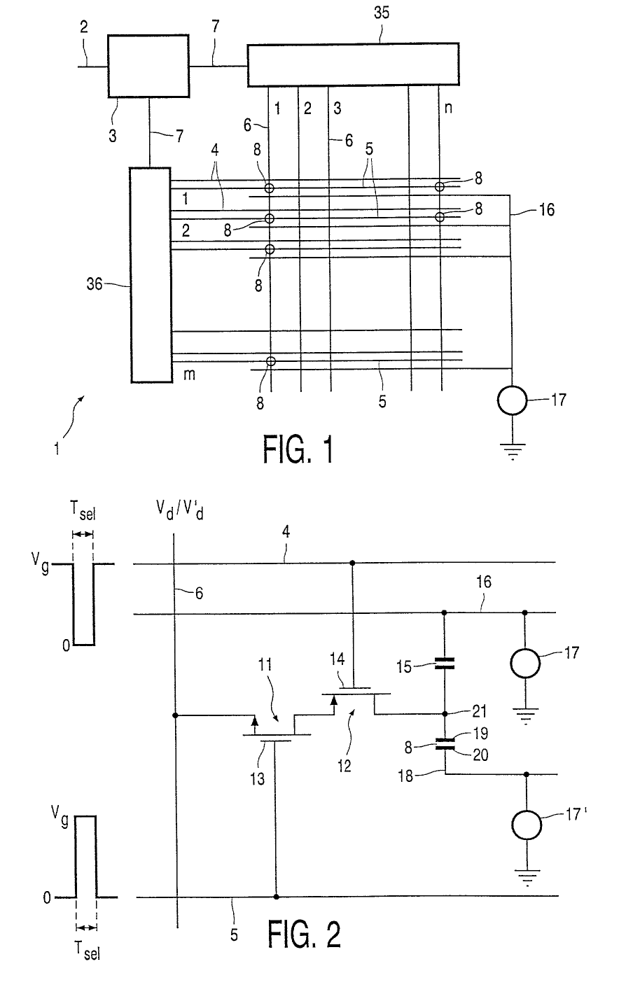

FIG. 1 shows diagrammatically a display device with a matrix of pixels,

FIG. 2 shows a detail of the display device of FIG. 1, embodying the invention,

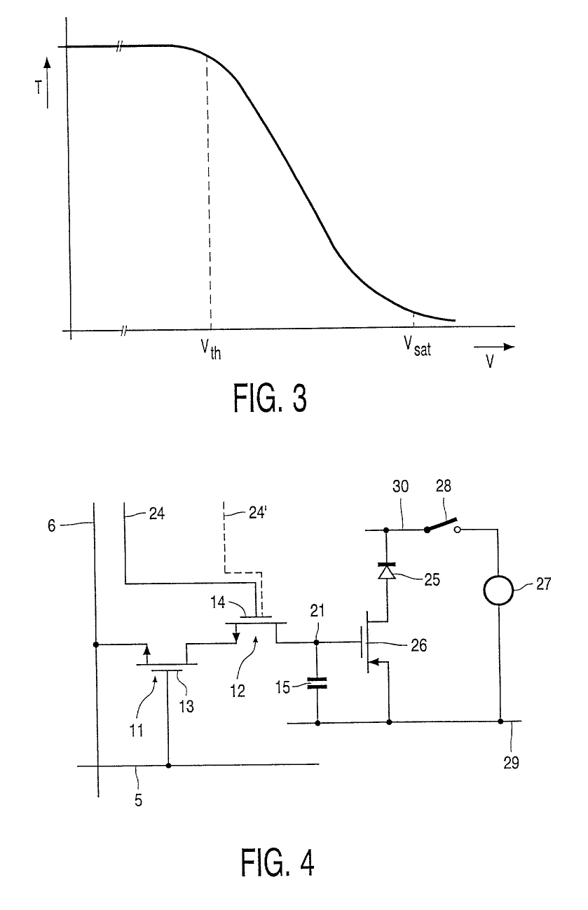

FIG. 3 shows a transmission/voltage characteristic curve for a liquid crystal cell as used in the display device of FIG. 1, while

FIG. 4 shows the use of the invention in a display device based on light-emitting pixels, and

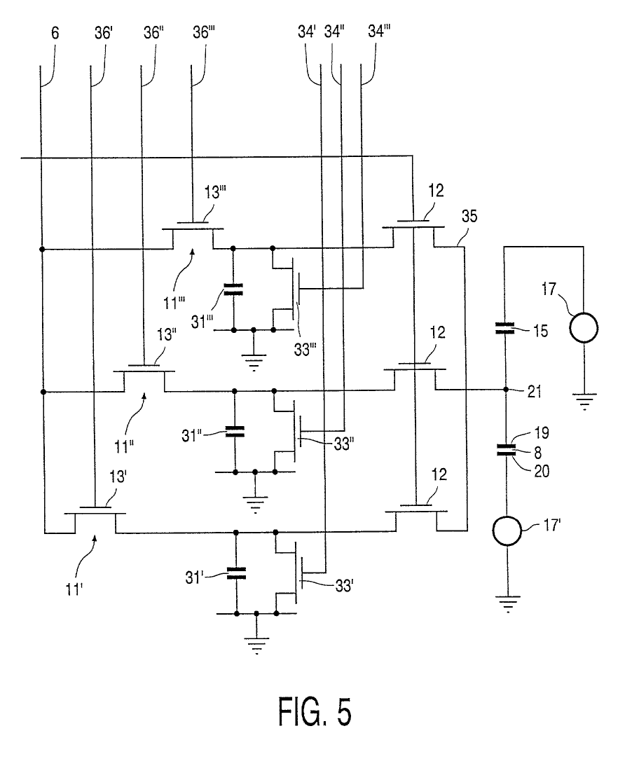

FIG. 5 shows a variant of FIG. 2.

The Figures are diagrammatic and not drawn to scale. Corresponding elements are generally denoted by the same reference numerals.

FIG. 1 is an electrical equivalent of a display device 1 to which the invention is applicable. It comprises a matrix of pixels 8 at the area of crossings of m row or selection electrodes 5 and n column or data electrodes 6. The row electrodes are consecutively selected via a row driver 36, while the column electrodes are supplied with data via a data register 35. To this end, incoming data signals 2 are first processed, if necessary, in a processor 3. Mutual synchronization takes place via drive lines 7.

In the present embodiment, the pixel 8 forms part of a liquid crystal display device. In the conventional active matrix TFT technology, TFT transistors associated with a pixel are activated via a selection pulse on the gate electrode, while the voltages on the data electrodes which are connected to the source electrodes of the TFT transistors define the voltage on the picture electrodes connected to the drain electrodes. According to the invention, a data electrode 6 (FIG. 2) is connected to the pixel via a field effect transistor 11 (TFT) of the first type (the n type in this embodiment) in series with a second field effect transistor 12 (TFT) of a second, opposite type (the p type in this embodiment). The drain of TFT 11 is connected to the source of TFT 12 while the gate electrode of the first field effect transistor 11 of the first type is connected to a selection electrode 5. In this embodiment, the gate electrode of the second field effect transistor 12 is connected to an extra selection electrode 4. A suitable technology of manufacturing TFTs of the p type as well as the n type uses polysilicon transistors (“high temperature poly” or “low temperature poly”) but also the use of monocrystalline silicon or other semiconductor materials is not excluded. The drain of transistor 12 is connected to an electrode 19 of a pixel 8 and also to a plate of a storage capacitor 15 provided in the conventional manner. The other plate of the storage capacitor is connected to a voltage source 17 via an extra electrode 16. The transistors 11, 12 and the electrodes 4, 5, 6, 16 are present on a first substrate of, for example, glass or a synthetic material. The counter electrode 20 of the pixel 8 is connected to a voltage source 17′ via an electrode 18. In this embodiment, the same value is chosen for the voltages of the voltage sources 17, 17′.

In the embodiment of FIG. 2, a selection voltage V_{g} is supplied during selection to the selection electrode 5 (i.e. to the gate electrode of the first field effect transistor 11 of the first type), while the voltage at this selection electrode is 0 volt during non-selection. Simultaneously, a selection voltage of 0 volt is supplied during selection to the extra electrode 4 (i.e. to the gate electrode of the second field effect transistor 12 of the second type), while the voltage at this extra selection electrode is V_{g} during non-selection. Consequently, the two transistors 11, 12 are turned on during selection (it is assumed that the threshold voltages of the TFT transistors are approximately V_{Tn}=1.0 V (n-channel TFT 11) and V_{Tp}=−1.0 V (p-channel TFT 12). During non-selection (referred to as the “hold state”) the two transistors are turned off.

For positive pixel voltages, the data voltage V_{d} at a column electrode 6 is Vₜₕ≦V_{d}≦Vₛₐₜ, in which Vₜₕ and Vₛₐₜ are the threshold and saturation voltage, respectively, of the liquid crystal (see FIG. 3). A customary value for a liquid crystal material is Vₜₕ=1.5 V. For a contrast of 300:1, Vₛₐₜ is usually 4.5 V in a transmissive display device. In a reflective display device, notably in said automotive applications and telephones, much less contrast (for example, 10:1) is sufficient so that a voltage of about 3 V can be chosen for Vₛₐₜ. The counter electrode 18 (and therefore also the extra line 4) has a voltage V_{CE}=0 V. When the selection line 5 receives a voltage V_{g} and the extra electrode simultaneously receives a voltage 0 V, the two transistors 12, 13 will be turned on and the point 21 will be charged to a voltage Vₜₕ≦V_{A}≦Vₛₐₜ so that the pixel capacity Vₚ is charged to Vₜₕ≦Vₚ≦Vₛₐₜ.

When pixel voltages having an opposite (here, negative) value must be written in the next frame (or in the next row, dependent on the drive mode) the counter electrode is switched to a voltage V_{CE}=Vₛₐₜ+Vₜₕ, i.e. to 4.5 V in the embodiment of a reflective display device. The voltage at the point 21 then increases to Vₛₐₜ+2Vₜₕ≦V_{A}≦2Vₛₐₜ+Vth, which corresponds to 6.0 V≦V_{A}≦7.5 V in the case of the above-mentioned values.

With a value of V_{g}=6 V, it now holds that, if the circuit only used an n-channel TFT as a switch, it would remain blocked, whereas it would start conducting when only a p-channel TFF were used as a switch because the gate is at 6 V and the pixel connection at the location of point 21 can receive a voltage of 7.5 V so that the drain of transistor 12 can function as a source. Since there is a series arrangement of an n-type and a p-type TFT, there cannot be a current flow. When the relevant row is written negatively, at which the data voltage V_{d}′ on the column is again chosen to be in the range of Vₜₕ≦V_{d}′≦Vₛₐₜ to maintain the total voltage range as small as possible, then the voltage at point 21 (V_{A}) will be Vₜₕ<V_{A}<Vₛₐₜ and the pixel voltage Vₚ will be V_{A}−V_{CE}, in which V_{CE}=Vₛₐₜ+Vₜₕ so that −Vₛₐₜ≦Vₚ≦−Vₜₕ.

When the voltages are to be written again positively in the next frame (or the next row), then the voltage at the counter electrode 20 (and also on the extra line 16) is switched to 0 V again. The voltage at point 21 will then be −Vₛₐₜ<V_{A}<−Vₜₕ. If only the n channel TFT 13 were used, it would start conducting, but the series arrangement of an n-type and a p-type transistor now also prevents the occurrence of conduction. Consequently, the voltage range of the gate voltage V_{g} may also be limited to Vₛₐₜ+2Vₜₕ, about 6 V in the relevant embodiment.

The power consumption in the circuit of FIG. 1, 2 may be further decreased when information does not change for a longer period of time. In this respect it is to be noted that the data need not necessarily be inverted after every frame (or after every row). A DC drive mode is very well possible. In that case, it can be ascertained in the drive circuit 3, or with an extra circuit at the input or output of register 5, that the data V_{d} at one of the column electrodes 6 does not change during a plurality of consecutive selections. The extra circuit may then be used to cause the extra electrode 4 to switch at a smaller frequency (from V_{g} to 0 V). The picture information is then refreshed at a lower frequency, which takes less dissipation. The information is maintained for a longer period of time as the storage capacitor 15 has a higher capacitance.

In the embodiment of FIG. 4, the series arrangement of two complementary TFT transistors in a display device based on electroluminescence is used to apply a charge (corresponding to a value of the picture information) to a capacitor 15. The capacitor 15 functions as a storage element and, together with a transistor 26, it forms a current source which, dependent on the impressed voltage at point 21, defines the current flowing during selection through the transistor 26 and hence through the pixel (the (O)LED or (P)LED) 25. To this end, for example, the switch 28 shown diagrammatically is closed during selection so that the voltage source 27 provides the series arrangement of the current source 15, 26 and the LED 25 between the lines 29, 30 with the required voltage so that the LED 25 luminesces with the desired intensity. The voltage applied to the capacitor 15 is defined by the data voltage at column electrode 6. However, the supply of the voltage is not only defined by selection via selection electrode 5 but the extra electrode 24 should also select transistor 12 via gate 14. This can be realized by providing an inverse pulse, similarly as in the embodiment of FIGS. 1, 2. The selection pulse at electrode 24 may also be supplied in a conditioned way so that the information can be presented at a lower frequency. Since the two transistors 11, 12 are arranged in series, logics can be driven thereby, (the two transistors have an AND function). By providing one of the transistors (transistor 12 in this embodiment) (or both transistors) with an extra gate connection 24′, the possibilities of driving logics are even further extended. By arranging one or more transistors parallel to the transistors 11, 12, an OR function can also be realized.

A completely different display device according to the invention is shown in FIG. 5. The sources of the three n-type transistors 11′, 11″, 11″′ are connected to electrode 6. The drains of the transistors 11′, 11″, 11 ″′ are connected to associated capacitors 31′, 31 ″, 31″′, whose capacitances are in the ratio of 4:2:1. The electrodes 36′, 36″, 36″′ are coupled to, for example, the output of a digital register, whose output is presented to the gate electrodes 13 during selection (for example, via an AND gate). Dependent on the digital values in the register, the transistors 11′, 11″, 11″′ are turned on or off and, dependent on these digital values, the assembly of capacitors 31′, 31″, 31″′ at point 35 receives a voltage which may assume eight values between 0 volt and a given maximum with 6 intermediate values (D/A conversion). To remove charge from the capacitors 31 in advance, they are shunted to earth with transistors 33 whose gates are controlled via lines 34. The inverse signal of the gate electrodes 36 is supplied to the lines 34. This discharge may also take place with the digital information, prior to the selection via gates 13, by selecting all transistors and giving the line 6 a voltage of 0 V.

An additional advantage of this device is that the voltage at the electrode 6 may be adjustable, dependent on the properties of the liquid crystal (or the LEDs) (scalable D/A conversion). By subsequently selecting transistor 12, the voltage is transferred to point 35 and thereby defines the voltage across the pixel (and the transmission or reflection).

The invention is of course not limited to the embodiments described above. As stated, for example, monocrystalline transistors instead of polycrystalline transistors may be used. If necessary, the use of bipolar transistors is also possible.

The protective scope of the invention is not limited to the embodiments described. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A display device (1) comprising, on a substrate, a matrix of selection electrodes (5) and data electrodes (6), with a pixel and at least a field effect transistor (11) of a first type at the area of a crossing of the selection electrodes and data electrodes, characterized in that the display device comprises, between the data electrode and the pixel, in series with a field effect transistor (11) of the first type, at least a second field effect transistor (12) of a second, opposite type, the gate electrode of one of the field effect transistors being connected to a selection electrode(s) (5).

2. A display device as claimed in claim 1, characterized in that the gate electrode (13) of the first field effect transistor (11) of the first type is connected to the selection electrode (5).

3. A display device as claimed in claim 2, characterized in that the gate electrode (14) of the second field effect transistor (12) of the second type is connected to an extra selection electrode (4).

4. A display device as claimed in claim 1, characterized in that the gate electrode (14) of the second field effect transistor (12) of the second type is connected to a data electrode (6, 24).

5. A display device as claimed in claim 3, characterized in that the display device comprises drive means (3, 7, 35, 36) for supplying selection pulses to the gate electrodes of the field effect transistors.

6. A display device as claimed in claim 5, characterized in that the selection pulses are simultaneously supplied to the gate electrodes of the field effect transistors.

7. A display device as claimed in claim 4, characterized in that the display device comprises drive means (3, 7, 35, 36) for the supply of selection pulses to the gate electrode of the first field effect transistor (11) and for the conditioned supply of selection pulses to the gate electrode of the second field effect transistor (12).

8. A display device as claimed in claim 7, characterized in that the selection pulses for the first field effect transistor differ in time duration from those for the second field effect transistor.

9. A display device as claimed in claim 7 or 8, characterized in that the drive means comprise means for temporarily suppressing the selection pulses of at least one of the field effect transistors.

10. A display device as claimed in claim 8 or 9, characterized in that the selection pulses are supplied at a different frequency to the gate electrodes of the field effect transistors.

11. A display device as claimed in claim 2, characterized in that the gate electrode of the second field effect transistor of the second type is connected to a data electrode.

12. A display device as claimed in claim 1, characterized in that the display device comprises a capacitor (15), an electrode of which is connected to an electrode of the pixel.

13. A display device as claimed in claim 1, characterized in that the pixel comprises at least a layer of liquid crystal material between two picture electrodes.

14. A display device as claimed in claim 13, characterized in that the display device comprises a capacitor (15) between the electrode (19) of the pixel and an electrode (16) connected to a terminal of a power supply voltage (17).

15. A display device as claimed in claim 1, characterized in that the display device comprises a capacitor (31), an electrode of which is connected to the common point of the field effect transistor of the first type and the field effect transistor of the second type.

16. A display device as claimed in claim 15, characterized in that the display device comprises a plurality of field effect transistors of the first type between the selection electrode and a plurality of capacitances associated with each field effect transistor of the first type.

17. A display device as claimed in claim 16, characterized in that the selection electrode is connected to a bias voltage.

18. A display device as claimed in claim 17, characterized in that the bias voltage is variable.

19. A display device as claimed in claim 1, characterized in that the pixel comprises at least a luminescent element (25) in series with an adjusting transistor (26).
